(19) United States
(12) Patent Application Publication
(10) Pub. No.: US 2016/0242399 A1
(43) Pub. Date: Aug. 25, 2016

(54) Hybrid Spinner-blade and Plug Fishing Lure

(71) Applicant: MacGregor McClelland, Brandywine, MD (US)

(72) Inventor: MacGregor McClelland, Brandywine, MD (US)

(21) Appl. No.: 15/048,762

(22) Filed: Feb. 19, 2016

Related U.S. Application Data
(60) Provisional application No. 62/118,309, filed on Feb. 19, 2015.

(51) Int. Cl. A01K 85/10; A01K 85/18

(52) U.S. Cl. CPC A01K 85/10; A01K 85/18

(57) ABSTRACT

A new form of hybrid fishing lure configured to exhibit the advantages of both a spinner blade lure and a traditional plug lure or crank bait is described. The lure device is equipped with a reflective spinner blade or blade configured to rotate about a swivel mechanism when pulled through the water. A plug lure is positioned below the reflective spinner blade, and is in communication with the spinner blade via a spinner blade frame and an extension. The plug lure is equipped with treble hooks to snare fish, as well as a squared lip, disposed at the front of the plug lure, configured to draw the lure device deeper into the water as the lure device is pulled through the water via a conventional fishing line. The spinner blade frame and extension are configured to eliminate the possibility of the spinner blade coming into contact with the plug lure during transit through the water, when cast into the water, or when removed from the water.

### CONTINUITY

This application is a non-provisional application of provisional patent application No. 62/118,309, filed on Feb. 19, 2015, and priority is claimed thereto.

### FIELD OF THE PRESENT INVENTION

The present invention relates generally to fishing devices and methods, and more specifically, to fishing lures configured to mimic the natural movement of living fish swimming through the water.

### BACKGROUND OF THE PRESENT INVENTION

The traditional fishing lure has evolved over time to become an ever-more proficient tool that is critical to catching many different forms of fish. Many different types of lures exist on the market today, each generally designed to excel at catching a specific set or sets of fish within either freshwater, salt water, or both. Traditional plug or crank bait lures, commonly equipped with a down-paddle or lip, eyelet, and conventional hooks (tri-hooks, double-hooks, or single hooks) have been proven to excel at snaring a wide assortment of fish.

Ideally, a spinner blade would be most beneficial as a means to attract fish, as the spinning, shiny spinner blade is designed to mimic the scales of authentic fish, shimmering in the sunlight or moonlight as they swim through the water.

Throughout the prior art, no fishing lure has positioned the spinner blade above the crank bait plug, and oriented it to remain above the lure when pulled through the water, which is an ideal placement, as the spinner blade is provided enough room to spin freely.

Thus, there is a need for a new fishing lure that combines the life-like motion and shimmering of a spinner blade lure, while maintaining the strength and diving ability of a crank bait plug lure. Such a new lure would preferably maintain the spinner blade above the plug lure via an extension frame, so as to ensure the optimal placement of the spinner blade is maintained during use, and that the spinner blade and the plug lure remain tangle-free.

### SUMMARY OF THE PRESENT INVENTION

The present invention is a hybrid fishing spinner blade and crank bait lure configured to easily entice fish to treble hooks on a lure with the aid of the shimmer and motion of a rotating spinner blade. The spinner blade is positioned above the lure, and is preferably affixed to a conventional swivel mechanism. A support frame and extension arm are configured to connect the swivel mechanism to the crank bait lure. The support frame and extension arm are preferably composed of a durable metal that is capable of flexing slightly, while remaining rigid enough to remain in position while being retrieved.

The lure of the present invention is preferably similar in size and shape to a plug or crank bait lure. The lure has at least one treble hook disposed along the bottom of the lure. Additionally, the lure is equipped with a lip, disposed below the horizontal axis of the lure. The lip is angled as to drive the present invention deeper into the water when the line is pulled or wound. The lip of the present invention is preferably squared, to ensure that the axis of the lure remains consistent and does not spin. As the lure is pulled through the water, the lip forces the lure and spinner blade deeper into the water. Simultaneously, the spinner blade rotates through the water as the lure is pulled, causing the entire lure to vibrate and shake in the water, helping to attract fish. Likewise, the force of the water against the support frame and extension arm add tension to the support frame, bending the support frame down towards the at least one treble hook located at the dorsal end of the lure.

The support frame and extension arm of the present invention are preferably oriented such that they maintain the spinner blade above the lure, even when the device is pulled through the water quickly, or during trolling.

### BRIEF DESCRIPTION OF THE DRAWINGS

The present invention will be better understood with reference to the appended drawing sheets, wherein:

FIG. 1 displays the primary embodiment of the present invention as seen from the side.

FIG. 2 exhibits an alternate embodiment of the present invention, showing the spinner blade disposed below the crank bait lure.

### DETAILED DESCRIPTION OF THE PREFERRED EMBODIMENT

The present invention generally comprises a hybrid fishing lure device equipped with both a spinner blade (20) and a lure (10). The lure (10) is preferably similar in size and scope to a crank bait or plug lure. As such, the lure (10) of the present invention has a lip (80) affixed to a front portion of the lure (10) and oriented under the center horizontal axis of the lure (10). At least one treble hook (30) is disposed at the dorsal end of the lure (10). Additionally, at least one treble hook (30) may be disposed at the bottom, near the center of the lure (10). The lure (10) is preferably composed of a plastic, acrylic or similar polymer. The at least one treble hook (30) is preferably made of metal or a metallic alloy. A conventional eyelet is disposed at the front of the lure (10).

The preferred embodiment of the present invention is preferably equipped with a split ring (90) in communication with the eyelet. An extension arm (70) extends upward and away from the lure (10) at approximately 45 degrees, wherein it is bent into a U-shape, facilitating the strength and distribution of tension to a support frame (50). The support frame (50) extends upward and above the lure (10) of the present invention at a 90 degree angle from the extension arm (70). The support frame (50) is configured to support the spinner blade (20) of the present invention, and ensure that it remains in position above the lure (10) during use. The support frame (50) is affixed to a swivel mechanism (40). The opposing end of the swivel mechanism (40) is affixed to the spinner blade. The swivel mechanism (40) ensures that the spinner blade may spin freely when pulled through the water, and help to ensure that the line does not become twisted or tangled.

The spinner blade (20) of the present invention is preferably made from sterling silver, a sterling silver coating, or stainless steel.

It should be understood that the lure (10) of the present invention is configured to remain on an even keel, and is configured to descend at a consistent angle when the line is cranked or pulled. The spinner blade (20) is configured to remain distant enough from the lure (10) (crank bait) so that both can move freely. The lure (10) is configured to oscillate slight side to side and dive deeper into the water when the line is pulled, while the spinner blade spins freely above the lure (10), preferably making complete revolutions about the swivel mechanism (40). Thus, the two separate actions (oscillation of the lure (10) and rotation of the spinner blade (20)) double the attraction for fish. A resistance loop (60) is preferably present at the juncture of the extension arm (70) and the support frame (50), which helps ensure that spring-like resistance remains when strain from water pulls the spinner blade (20) towards the rear of the lure (10) while cranking or pulling the fishing line. The resistance loop (60) helps the spinner blade (20) to move naturally while tension ensures that the spinner blade (20) does not travel far from the vertical axis.

With the spinner blade (20) disposed above the lure (10), the action of the lure (10) and the spinner blade (20) can remain as intended, without contact, friction, or entanglement with one another. If the configuration of the present invention were to be oriented in another fashion, the spinner blade (20) would quickly get entangled with the at least one treble hook (30) causing air bubbles, diminishing the efficacy of the lure, and ensuring that the plug or crank-bait does not perform correctly. Additionally, positioning the spinner blade on top of the lure (10) mimics a school of fish. The rotating blade of the spinner blade and its shiny metal composition is configured to act as a light reflector. If it were oriented on the side or below the crank bait, it might not reflect light and/or is easily snared on the at least one treble hook (30) hanging at the bottom and/or end of the lure (10).

If the length of the support frame (50) is not accurate, then the spinner blade (20) will bind against the lure (10) or at least one treble hook (30). In all configurations of the present invention, the spinner blade (20) is affixed via an extension frame which keeps the spinner blade (20) at a distance from the at least one treble hook (30) such that a fish may strike and hit the hooks without any occurrence of entanglement. When the spinner blade (20) is disposed above the lure (10), as oriented in the preferred embodiment of the present invention, the spinner blade is closest to the sun, maximizing the light reflectivity of the metallic spinner blade (20). In the preferred embodiment of the present invention, the spinner blade (20) is smaller than the lure (10), which is preferably a crank bait/plug lure. In alternate embodiments of the present invention, it can be envisioned that a spinner blade (20) that is larger than the lure (10) for use in murky water with very low visibility; however, this is not preferred for the primary embodiments of the present invention.

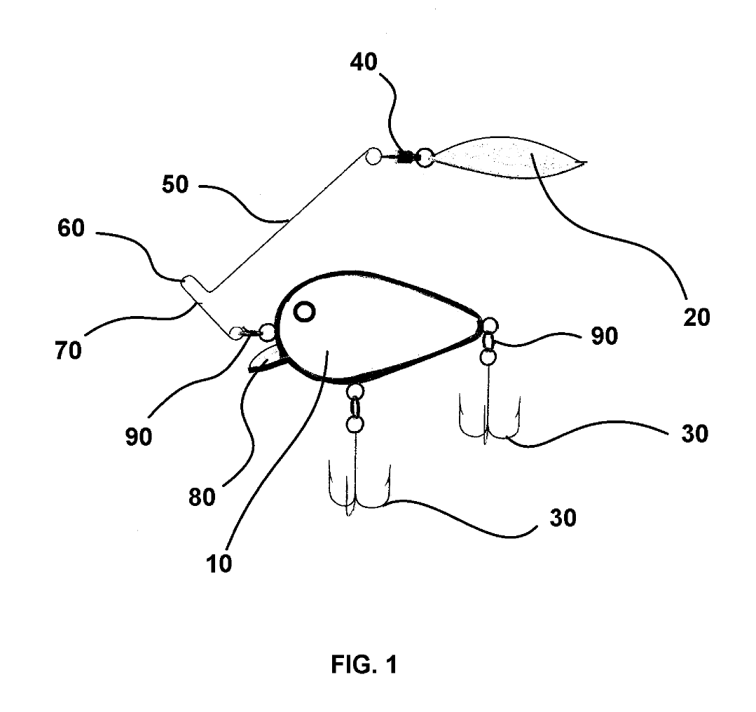

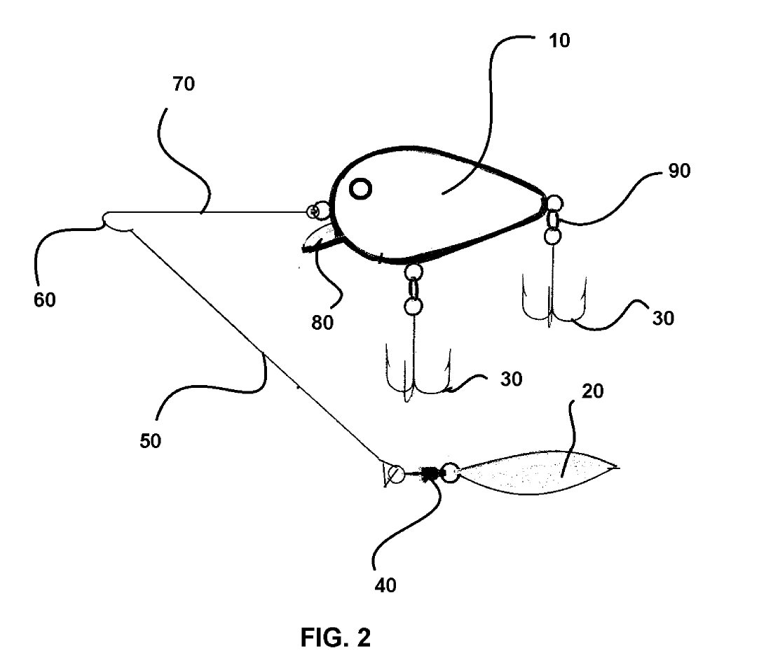

An alternate embodiment of the present invention is disclosed in FIG. 2, which shows the present invention having a modified extension arm (70) and support frame (50), facilitating the placement of the spinner blade (20) below the lure (10). As such, the extension arm (70) and support frame (50) are longer, forming an ‘L’ shape that extends beyond the reach of the at least one treble hook (30) to prevent snags. As shown in FIG. 2, both the extension arm (70) and support frame (50) are longer than those shown in the preferred embodiment of the present invention of FIG. 1.

Additional alternate embodiments of the lure device of the present invention include variations on the size, weight, and color of the lure (10), as well as the angle of the lip (80) in relation to the body of the lure (10). In all embodiments of the present invention, it is envisioned that the lip (80) is squared. Similarly, the angle of the extension arm (70) and support frame (50) may vary with the type of fish targeted, and what waters in which the present invention is employed.

In all embodiments of the present invention, it is envisioned that the spinner blade (20) is smaller in size than the lure (10). If the spinner blade (20) were to be made too large or too heavy, the spinner blade (20) will cause the lure (10) to be off balance, and the spinner blade (20) will not spin properly. The spinner blade (20) of the present invention is preferably of the willow leaf style, and is preferably available in a wide variety of colors. Each of the colors available is preferably shiny and reflective. The extension arm (70) and the support frame (50), together comprising the ‘L’ shaped arm, preferably extends at least two inches from the lure (10). Additionally, the support frame (50) preferably extends at least two inches from the resistance loop (60). As long as the lure (10) is moving properly, nothing will entangle the spinner blade (20) or extension arm (70).

Likewise, in all embodiments of the present invention, the lip (80) is square billed. Any other shape of lip (80) causes the lure (10) to roll, which is undesired. The depth to which the lure (10) will dive when pulled by the fishing line is determined by the size of the lip (80). It should be noted that the ideal number of instantiations of the at least one treble hook (30) of the present invention is two. The maximum number of instantiations of the at least one treble hook (30) of the present invention present is three.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A hybrid crank-bait and spinner lure apparatus comprising:
a crank-bait lure;
at least one treble hook;
wherein said at least one treble hook is disposed at a bottom of said crank-bait lure;
a lip, said lip disposed on a front of said crank-bait lure;
an eyelet, said eyelet disposed at said front of said crank-bait lure, above said lip;
an extension arm;
wherein said extension arm is configured to extend up and away from said crank-bait lure;
a support frame, said support frame in communication with said extension arm;
a spinner blade, said spinner blade in communication with said support frame via a swivel mechanism;
wherein said spinner blade is disposed above said crank-bait lure;
wherein said crank-bait lure is configured to descend in water when pulled via said eyelet; and
wherein said spinner blade is configured to spin about said swivel mechanism during use.

2. The apparatus of claim 1, wherein said eyelet is configured to receive fishing line.

3. The apparatus of claim 1, wherein said spinner blade is silver.

4. The apparatus of claim 1, wherein said spinner blade is metallic.

5. The apparatus of claim 1, wherein said extension arm is perpendicular to said support frame.

6. The apparatus of claim 1, wherein said extension arm and support frame maintains said spinner blade from binding on said at least one treble hook.

7. The apparatus of claim 1, wherein said crank-bait is configured to oscillate horizontally during use.

8. The apparatus of claim 1, further comprising:
a resistance loop, said resistance loop disposed at junction between said support frame and said extension arm; and
wherein said support frame and said extension arm form an shape.

9. The apparatus of claim 2, wherein said spinner blade is silver.

10. The apparatus of claim 3, wherein said extension arm and support frame maintains said spinner blade from binding on said at least one treble hook.

11. The apparatus of claim 8, wherein said lip is squared.

12. A hybrid plug and spinner lure apparatus comprising:
a crank-bait plug lure;
at least one treble hook;
wherein said at least one treble hook is disposed at a bottom of said crank-bait plug lure;
wherein said at least one treble hook is disposed at a rear of said crank-bait plug lure;
a lip, said lip disposed on a front of said crank-bait lure;
wherein said lip is squared;
an eyelet, said eyelet disposed at said front of said crank-bait lure, above said lip;
an extension arm;
wherein said extension arm is configured to extend up and away from said crank-bait lure;
a support frame;
a resistance loop, said resistance loop disposed at junction between said support frame and said extension arm;
wherein said support frame and said extension arm form an ‘L’ shape.
a spinner blade, said spinner blade in communication with said support frame via a swivel mechanism;
wherein said spinner blade is disposed above said crank-bait lure;
wherein said crank-bait lure is configured to descend in water when pulled via said eyelet; and
wherein said spinner blade is configured to spin about said swivel mechanism during use.

13. A hybrid plug and spinner lure apparatus comprising:
a crank-bait plug lure;
at least one treble hook;
wherein said at least one treble hook is disposed at a bottom of said crank-bait plug lure;
wherein said at least one treble hook is disposed at a rear of said crank-bait plug lure;
a lip, said lip disposed on a front of said crank-bait lure;
wherein said lip is squared;
wherein said lip is bill shaped;
an eyelet, said eyelet disposed at said front of said crank-bait lure, above said lip;
an extension arm;
wherein said extension arm is configured to extend up and away from said crank-bait lure;
a support frame;
a spinner blade, said spinner blade in communication with said support frame via a swivel mechanism;
wherein said spinner blade is disposed below said crank-bait lure;
wherein said crank-bait lure is configured to descend in water when pulled via said eyelet; and
wherein said spinner blade is configured to spin about said swivel mechanism during use.
